(19) United States
(12) Patent Application Publication
(10) Pub. No.: US 2022/0237376 A1
(43) Pub. Date: Jul. 28, 2022

(54) METHOD, APPARATUS, ELECTRONIC DEVICE AND STORAGE MEDIUM FOR TEXT CLASSIFICATION

(71) Applicant: BEIJING BAIDU NETCOM SCIENCE TECHNOLOGY CO., LTD., Beijing (CN)

(72) Inventors: Yaqing Wang, Beijing (CN); Dejing Dou, Beijing (CN)

(73) Assignee: BEIJING BAIDU NETCOM SCIENCE TECHNOLOGY CO., LTD., Beijing (CN)

(21) Appl. No.: 17/718,285

(22) Filed: Apr. 11, 2022

(30) Foreign Application Priority Data
Aug. 25, 2021 (CN) 202110984069.2

(51) Int. Cl. G06F 40/279; G06F 40/253; G06F 40/117; G06N 3/04

(52) U.S. Cl. CPC G06F 40/279; G06F 40/253; G06F 40/30; G06N 3/0454; G06F 40/117

(57) ABSTRACT

A computer-implemented method for text classification is provided. The method for text classification includes obtaining an entity category set and a part-of-speech tag set associated with a text. The method further includes constructing a first isomorphic graph for the entity category set and a second isomorphic graph for the part-of-speech tag set. A node of the first isomorphic graph corresponds to an entity category in the entity category set, and a node of the second isomorphic graph corresponds to a part-of-speech tag in the part-of-speech tag set. The method further includes obtaining, based on the first isomorphic graph and the second isomorphic graph, a first text feature and a second text feature of the text through a graph neural network. The method further includes classifying the text based on a fused feature of the first text feature and the second text feature.

### CROSS REFERENCE TO RELATED APPLICATION

This application claims priority to Chinese Patent Application No. 202110984069.2 filed on Aug. 25, 2021, the contents of which are hereby incorporated by reference in their entirety for all purposes.

### TECHNICAL FIELD

The present disclosure relates to the technical field of artificial intelligence, in particular to natural language processing and deep learning, and in particular to a method, an apparatus, an electronic device, a computer-readable storage medium and a computer program product for text classification.

### BACKGROUND

Artificial intelligence is a subject that studies making computers to simulate some human thinking processes and intelligent behaviors (such as learning, reasoning, thinking, and planning), and has both hardware-level technology and software-level technology. The hardware technology of artificial intelligence generally includes sensors, dedicated artificial intelligence chips, cloud computing, distributed storage, big data processing and other technology. The software technology of artificial intelligence mainly includes computer vision technology, speech recognition technology, natural language processing technology, machine learning/deep learning, big data processing technology, knowledge graph technology and other major directions.

In recent years, the usage of a short text in Internet media has been increasing, which makes information extraction from the short text very important. However, since there may be a small quantity of words contained in the short text, traditional text processing methods often fail to achieve desirable classification results. At the same time, with the rapid development of media, the speed for generating texts is getting higher and higher, which also prompts an urgent need for a more effective text classification method for the short text.

Methods described in this section are not necessarily methods that have been previously conceived or employed. Unless otherwise indicated, it should not be assumed that any of the methods described in this section qualify as prior art merely by virtue of their inclusion in this section. Similarly, unless otherwise indicated, problems raised in this section should not be considered to be recognized in any prior art.

### SUMMARY

The present disclosure provides a method, an apparatus, an electronic device, a computer-readable storage medium and a computer program product for text classification.

According to one aspect of the present disclosure, a method for text classification is provided, including obtaining an entity category set and a part-of-speech tag set associated with a text, constructing a first isomorphic graph for the entity category set and a second isomorphic graph for the part-of-speech tag set, wherein a node of the first isomorphic graph corresponds to an entity category in the enmity category set, and a node of the second isomorphic graph corresponds to a part-of-speech tag in the part-of-speech tag set; obtaining, based on the first isomorphic graph and the second isomorphic graph, a first text feature and a second text feature of the text through a graph neural network; and classifying the text based on a fused feature of the first text feature and the second text feature.

According to another aspect of the present disclosure, an electronic device is provided, including at least one processor, and a memory in communication connection to the at least one processor, wherein the memory stores instructions executable by the at least one processor, and the instructions, when executed by the at least one processor, enable the at least one processor to perform the method as described above.

According to another aspect of the present disclosure, a non-transitory computer-readable storage medium storing computer instructions is provided, wherein the computer instructions are configured to enable a computer to perform the method as described above.

It should be understood that what has been described in this section is not intended to identify key or critical features of the embodiments of the present disclosure, nor is it intended to limit the scope of the present disclosure. Other features of the present disclosure will become readily understood from the following description.

### BRIEF DESCRIPTION OF THE DRAWINGS

The accompanying drawings illustrate example embodiments and constitute a part of the specification, and together with the written description of the specification serve to explain example implementations of the embodiments. The shown embodiments are for illustrative purposes only and do not limit the scope of the claims. Throughout the accompanying drawings, the same reference numerals refer to similar but not necessarily identical elements.

FIG. 1 shows a schematic diagram of an example system in which various methods and apparatuses described herein may be implemented according to embodiments of the present disclosure.

FIG. 2 shows a flowchart of a method for text classification according to an embodiment of the present disclosure.

FIG. 3 shows a flowchart of a method for text classification according to another embodiment of the present disclosure.

FIG. 4 shows a schematic diagram for illustrating a method for text classification according to an embodiment of the present disclosure.

FIG. 5 shows a block diagram of an apparatus for text classification according to an embodiment of the present disclosure.

FIG. 6 shows a block diagram of an apparatus for text classification according to another embodiment of the present disclosure.

FIG. 7 shows a structural block diagram of an electronic device that may be applied to embodiments of the present disclosure.

### DETAILED DESCRIPTION

Example embodiments of the present disclosure are described below with reference to accompanying drawings, which include various details of the embodiments of the present disclosure to facilitate understanding and should be considered as example only. Accordingly, those of ordinary skill in the art should recognize that various changes and modifications of the embodiments described herein can be made without departing from the scope of the present disclosure. Similarly, descriptions of well-known functions and constructions are omitted from the following description for clarity and conciseness.

In the present disclosure, unless otherwise specified, the use of terms “first”, “second”, etc. for describing various elements is not intended to limit the positional relationship, timing relationship or importance relationship of these elements, and such terms are only used to distinguish one element from another. In some examples, a first element and a second element may refer to the same instance of the elements, while in some cases they may refer to different instances based on the description of the context.

Terms used in the description of the various examples in the present disclosure are for the purpose of describing particular examples only and are not intended to be limiting. Unless the context clearly dictates otherwise, if the quantity of an element is not expressly limited, the element may be one or more. Furthermore, as used in the present disclosure, the term “and/or” covers any one and all possible combinations of listed items.

In the related art, a graph neural network based method in which a single short text or a dataset of short texts is modeled is used to classify the short text. For the case of modeling the single short text, because it is only the words contained in the text that are used, semantic information that can be used is limited, resulting in a limited text classification effect. For the case of modeling the dataset of short texts, because the entire dataset is constructed on one isomorphic graph for processing, not only are there serious challenges in computational efficiency, but also a problem that the entire graph structure has to be changed when new semantic elements are introduced.

Aiming at the above problems, a method for text classification is provided according to an aspect of the present disclosure. An embodiment of the present disclosure will be described in detail below with reference to the accompanying drawings.

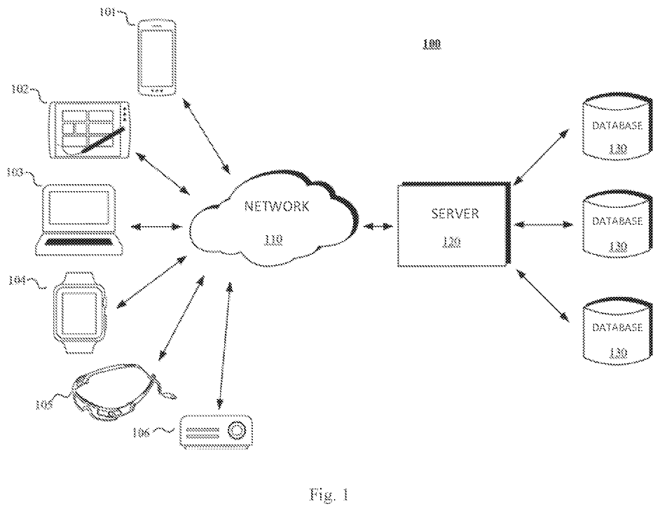

FIG. 1 shows a schematic diagram of an example system 100 in which various methods and apparatuses described herein may be implemented according to embodiments of the present disclosure. Referring to FIG. 1, the system 100 includes one or more client devices 101, 102, 103, 104, 105 and 106, a server 120, and one or more communication networks 110 coupling the one or more client devices to the server 120. The client devices 101, 102, 103, 104, 105, and 106 may be configured to run one or more applications.

In the embodiment of the present disclosure, the server 120 may run one or more services or software applications that enable execution of the method for text classification according to the embodiment of the present disclosure.

In some embodiments, the server 120 may also provide other services or software applications that may include a non-virtual environment and a virtual environment. In some embodiments, these services may be provided as web-based services or cloud services, for example, to users of the client devices 101, 102, 103, 104, 105 and/or 106 under a Software-as-a-Service (SaaS) model.

In the configuration shown in FIG. 1, the server 120 may include one or more components that implement functions executed by the server 120. These components may include software components, hardware components, or a combination thereof that are executable by one or more processors. The users operating the client devices 101, 102, 103, 104, 105 and/or 106 may in turn utilize one or more client applications to interact with the server 120 to utilize the services provided by these components. It should be understood that a variety of different system configurations are possible, which may differ from the system 100. Accordingly. FIG. 1 is an example of a system for implementing the various methods described herein, and is not intended to be limiting.

A text data source of the method for text classification according to the embodiment of the present disclosure may be provided by the users using the client devices 101, 102, 103, 104, 105 and/or 106. The client devices may provide an interface that enables the users of the client devices to interact with the client devices. The client devices may also output information to the users via the interface. Although FIG. 1 describes only six types of client devices, those skilled in the art will appreciate that any quantity of client devices may be supported in the present disclosure.

The client devices 101, 102, 103, 104, 105 and/or 106 may include various types of computer devices, such as portable handheld devices, general purpose computers (such as personal computers and laptops), workstation computers, wearable devices, gaming systems, thin clients, various messaging devices, sensors or other sensing devices. These computer devices may run various types and versions of software applications and operating systems, such as Microsoft Windows, Apple iOS, UNIX-like operating systems, and Linux or Linux-like operating systems (such as Google Chrome OS), or include various mobile operating systems, such as Microsoft Windows Mobile OS, iOS, Windows Phone, and Android. The portable handheld devices may include cellular phones, smart phones, tablet computers, personal digital assistants (PDAs), and so on. The wearable devices may include head-mounted displays and other devices. The gaming systems may include various handheld gaming devices, Internet-enabled gaming devices, and so on. The client devices are capable of running a variety of different applications, such as various Internet-related applications, communication applications (e.g., e-mail applications), and Short Message Service (SMS) applications, and may use various communication protocols.

The network 110 may be any type of network known to those skilled in the art that may support data communications using any of a variety of available protocols, including but not limited to TCP/IP, SNA, IPX, and so on. By way of example only, the one or more networks 110 may be a local area network (LAN), an Ethernet-based network, Token-Ring, a Wide Area Network (WAN), the Internet, a virtual network, a virtual private network (VPN), an intranet, an extranet, a public switched telephone network (PSTN), an infrared network, a wireless network (e.g., Bluetooth and WIFI) and/or any combination of these and/or other networks.

The server 120 may include one or more general purpose computers, dedicated server computers (e.g., personal computer (PC) servers, UNIX servers, and midrange servers), blade servers, mainframe computers, server clusters, or any other suitable arrangement and/or combination. The server 120 may include one or more virtual machines running a virtual operating system, or other computing architecture involving virtualization (for example, one or more flexible pools of logical storage devices that may be virtualized to maintain virtual storage devices of the server). In various embodiments, the server 120 may run one or more services or software applications that provide functions described below.

A computing unit in the server 120 may run one or more operating systems including any of the operating systems described above, as well as any commercially available server operating systems. The server 120 may also run any of a variety of additional server applications and/or middle-tier applications, including HTTP servers, FTP servers, CGI servers, JAVA servers, database servers, and so on.

In some implementations, the server 120 may include one or more applications to analyze and consolidate data feeds and/or event updates that are received from the users of the client devices 101, 102, 103, 104, 105 and 106. The server 120 may further include one or more applications to display data feeds and/or real-time events via one or more display devices of the client devices 101, 102, 103, 104, 105 and 106.

In some implementations, the server 120 may be a server of a distributed system, or a server combined with a blockchain. The server 120 may also be a cloud server, or an intelligent cloud computing server or an intelligent cloud host with artificial intelligence technology. The cloud server is a host product in a cloud computing service system to solve the problems for difficult management and weak business expansion in a traditional physical host and Virtual Private Server (VPS) services.

The system 100 may further include one or more databases 130. In some embodiments, these databases may be used to store data and other information. For example, one or more of the databases 130 may be used to store information such as audio files and video files. The databases 130 may reside in various locations. For example, a data storage library used by the server 120 may be local to the server 120, or may be remote from the server 120 and may be in communication with the server 120 via a network-based or dedicated connection. The databases 130 may be of different types. In some embodiments, a database used by the server 120 may be, for example, a relational database One or more of these databases may store, update, and retrieve data to and from the databases in response to commands.

In some embodiments, one or more of the databases 130 may also be used by applications to store application data. The databases used by the applications may be of different types, for example, key-value stores, object stores, or regular stores backed by a file system.

The system 100 of FIG. 1 may be configured and operated in various ways to enable application of the various methods and apparatuses described according to the present disclosure.

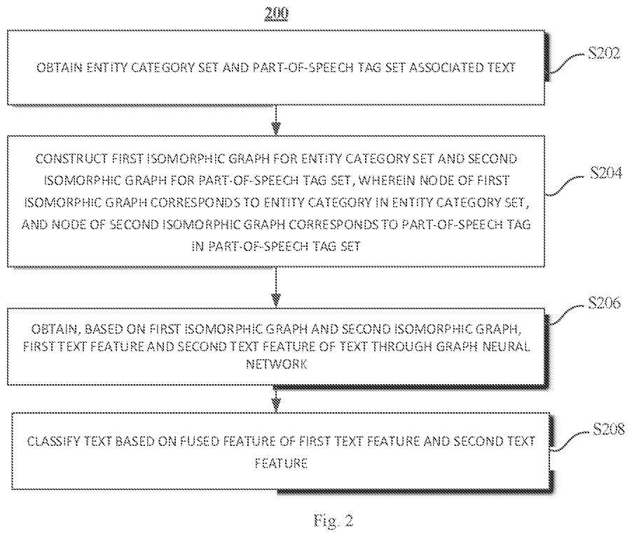

FIG. 2 shows a flowchart of a method 200 for text classification according to an embodiment of the present disclosure. As shown in FIG. 2, the method 200 for text classification includes the following steps:

S202, an entity category set and a part-of-speech tag set associated with a text are obtained;

S204, a first isomorphic graph for the entity category set and a second isomorphic graph for the part-of-speech tag set are constructed, wherein a node of the first isomorphic graph corresponds to an entity category in the entity category set, and a node of the second isomorphic graph corresponds to a part-of-speech tag in the pan-of-speech tag set;

S206, a first text feature and a second text feature of the text are obtained through a graph neural network based on the first isomorphic graph and the second isomorphic graph; and

S208, the text is classified based on a fused feature of the first text feature and the second text feature.

According to the method for text classification of the present disclosure, the classification of the text does not rely on the semantic information derived from the words themselves of the text. Individual text features of the text in other dimensions of semantic information are obtained, in which individual isomorphic graphs are constructed according to the other dimensions of semantic information. The individual text features of the text in the other dimensions are obtained through the graph neural network based on the individual isomorphic graphs. In this way, on one hand, the problem of the limited classification effect caused by relying on the semantic information of the text itself can be avoided, and on the other hand, the computing complexity faced by processing in one isomorphic graph can be reduced. Moreover, the problem that the entire graph structure has to be changed when new semantic elements are introduced can also be avoided, thereby improving the text classification efficiency.

In step S202, the text may typically be a short text, and may come from each short text in a pre-acquired dataset of short texts. Each short text in the dataset of short texts may or may not be related to each other. For example, the dataset of short texts may contain multiple short texts about various types of news, so the classification of each short text may imply determining which type of news the short text belongs to. As another example, the dataset of short texts may contain multiple short texts about a specific field (for example, the medical field), so the classification of each short text may imply determining which fine-grained category in that field the short text belongs to. As another example, the dataset of short texts may contain searching sentences or keywords used by a user to perform searching using a search engine, so the classification of each short text may imply identifying the user's searching intention. In the technical solution of the present disclosure, the collection, storage, use, processing, transmission, provision, disclosure, etc. of the user's personal information involved are all in compliance with the relevant laws and regulations, and do not violate public order and good customs.

As mentioned above, since there may be a small quantity of words contained in the short text, the semantic information derived from the words themselves is limited. The method according to the embodiment of the present disclosure may be capable of not being limited to the semantic information of the words themselves, and may improve the classification effect by fusing with other available semantic information.

On one hand, the entity category involved with the text to be classified may be determined through a known knowledge graph. Therefore, the entity category set may include the acquired at least one entity category. Here, the entity of the text may be obtained by the entity recognition techniques known in the art. And then the entity category (also referred to as the type) which the identified entity belongs to may be determined with the help of the knowledge graph. For example, the identified entity may be a person's name, and the entity category may be a category that represents an identity such as a student or an author. The entity category may be used to reflect the semantic information of the text.

The entity of the text may change with the content of the text itself, while the entity category of the text may be relatively limited and fixed. For example, in the case of performing natural language processing (for example, synonym replacement, or addition and deletion of words) on the text to obtain an extended text, the entity of the text may be changed accordingly, while the entity category of the text may be unchanged. This is because of the relatively limited and fixed quantity of entity categories from the knowledge graph. Thus, the method according to the embodiment of the present disclosure may provide a general and universal framework for dealing with the change of the text, so that when processing different texts, it will not be affected by the change of the content of the text itself.

On the other hand, since the text to be classified may have been marked with a part-of-speech tag (POS tag), the part-of-speech tag set about the text to be classified may be obtained, which may include the obtained at least one part-of-speech tag. The part-of-speech tag may also reflect the semantic information of the text, and may further reflect grammatical information.

In other words, for each text to be classified, the entity category set and the part-of-speech tag set associated with the text may be obtained, so that the respective isomorphic graphs may be constructed based on the two types of semantic elements. As mentioned above, the traditional text classification methods are often based on the word segmentation of the text, resulting in a limited classification effect. The method according to the embodiment of the present disclosure does not rely on the semantic information of the words constituting the text, and improves the classification effect by fusing with other available semantic information, thereby avoiding the problem of the limited classification effect caused by relying on the semantic information of the text itself.

In step S204, the individual isomorphic graphs may be constructed for the two types of semantic elements, i.e., the entity category and the part-of-speech tag. When the isomorphic graphs are constructed, the node in the isomorphic graph may correspond to the corresponding semantic element. That is, the node of the first isomorphic graph may correspond to the entity category in the entity category set, and the node of the second isomorphic graph may correspond to the part-of-speech tag in the part-of-speech tag set.

In addition, respective adjacency matrix and feature vector of node may be determined for the respective isomorphic graph. For example, with regard to the first isomorphic graph, the adjacency matrix used for the entity category node may be predefined by the knowledge graph, and the feature vector of the entity category node may be represented in a one-hot manner or may be a vector pre-trained from the knowledge graph. With regard to the second isomorphic graph, the adjacency matrix used for the part-of-speech tag node may be obtained in various ways, such as pointwise mutual information (PMI), co-occurrence counts, and word dependency grammar, and the feature vector of the part-of-speech tag node may be represented in a one-hot manner.

In step S206, the constructed isomorphic graphs may be fed to the graph neural network to obtain features of the text to be classified Specifically, the first text feature and the second text feature of the text to be classified may be obtained through the graph neural network based on the first isomorphic graph and the second isomorphic graph.

Since it is the two types of semantic elements of the entity category and the part-of-speech tag that are processed in step S202 and step S204, respectively, the first text feature and the second text feature obtained in step S206 correspond to the two types of semantic elements of the entity category and the part-of-speech tag as well. The method according to the embodiment of the present disclosure constructs the individual isomorphic graph for each semantic element so as to obtain the respective text feature from the respective isomorphic graph. By constructing the individual isomorphic graph for each semantic element, the computation complexity faced by processing in one isomorphic graph can be reduced, and the problem that the entire graph structure has to be changed when new semantic elements are introduced can also be avoided.

According to some embodiments, the graph neural network may include a first sub-graph neural network and a second sub-graph neural network, which are independent from each other. Here, the graph neural network may be, for example, a graph convolutional neural network for processing isomorphic graphs. First feature information for representing the first isomorphic graph and second feature information for representing the second isomorphic graph may be obtained. The first feature information may be input to the first sub-graph neural network to obtain the first text feature, and the second feature information may be input to the second sub-graph neural network to obtain the second text feature. In this way, by using individual isomorphic graphs for different semantic elements, the problem due to the use of the same isomorphic graph that embedding vector spaces are unequally generated when the nodes of different semantic elements are connected to each other can be avoided.

According to some embodiments, the first feature information and the second feature information may each include an adjacency matrix and feature vector of the node associated with the corresponding isomorphic graph. Specifically, the first feature information may include an adjacency matrix about the entity category node and the feature vector of the entity category node, and the second feature information may include the adjacency matrix about the part-of-speech tag node and the feature vector of the part-of-speech tag node. In this way, the text features of the text to be classified expressing on the corresponding isomorphic graphs may be obtained through the graph neural network from the isomorphic graphs.

In step S208, the first text feature and the second text feature may be fused with each other to obtain the fused feature. Based on the fused feature, a classifier (such as one or more fully connected layers) may be used to classify the text.

According to some embodiments, the fused feature may be obtained by performing addition calculation, weighted average calculation or feature splicing on the first text feature and the second text feature. In this way, it is convenient to flexibly select a manner of fusing the features according to different accuracy requirements and computing requirements.

As mentioned above, the classification of the text does not rely on the semantic information derived from the words themselves of the text. Individual text features of the text in other dimensions of semantic information are obtained, in which individual isomorphic graphs are constructed according to the other dimensions of semantic information. The individual text features of the text in the other dimensions are obtained through the graph neural network based on the individual isomorphic graphs. In this way, on one hand, the problem of the limited classification effect caused by relying on the semantic information of the text itself can be avoided, and on the other hand, the computing complexity faced by processing in one isomorphic graph can be reduced. The problem that the entire graph structure has to be changed when new semantic elements are introduced can also be avoided, thereby improving the text classification effect.

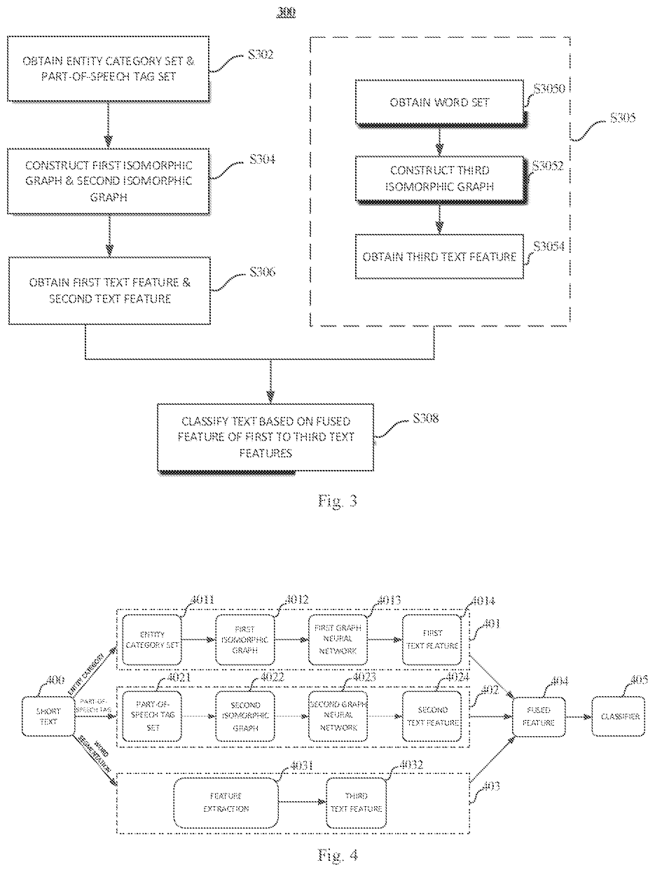

FIG. 3 shows a flowchart of a method 300 for text classification according to an embodiment of the present disclosure. Steps S302, S304, and S306 shown in FIG. 3 may be performed in the same manner as steps S202, S204, and S206 shown in FIG. 2, so the detailed descriptions thereof are omitted here.

According to some embodiments, compared to the method 200 for text classification as shown in FIG. 2, the method 300 for text classification as shown in FIG. 3 may further include step S305, in which a third text feature of the text is obtained based on a plurality of words constituting the text to be classified. As mentioned above, the method according to the embodiment of the present disclosure does not rely on the semantic element coming from the text segmentation. Nevertheless, this semantic element may be used as an additional dimension for obtaining a further text feature, thereby improving the accuracy of the fused feature. Accordingly, the eventually fused feature includes this further text feature as well.

According to some embodiments, the graph neural network may include a third sub-graph neural network for obtaining a third text feature. Accordingly, step S305 may further include the following steps: S3050, a word set including the plurality of words of the text to be classified is obtained; S3052, a third isomorphic graph for the word set is constructed, wherein a node of the third isomorphic graph corresponds to the word in the word set, and S3054, a third text feature is obtained through the third sub-graph neural network based on an adjacency matrix and a feature vector of the node associated with the third isomorphic graph.

In other words, the manner in step S305 in which the corresponding text feature is obtained based on the semantic element about the words of the text may be similar to the manner in steps S302 to S306 in which the corresponding text features are obtained based on the semantic elements about the entity category and the part-of-speech tag. Thus, by using the isomorphic graph to obtain the text feature associated with the semantic element of the words in the text, it is convenient to maintain the operational consistency of the overall method.

Specifically, in step S3050, the step of obtaining a word set may be implemented by the known word segmentation technology in the natural language processing, that is, a word set including a plurality of words may be obtained by segmenting the text to be classified. In step S3052, the node of the third isomorphic graph may be set to correspond to the word in the word set, that is, a word node. In step S3054, the adjacency matrix for the word node may be similar to that of the part-of-speech tag node, such as pointwise mutual information (PMI), co-occurrence counts, and word dependency grammar. The feature vector of the word node may be a word vector pre-trained from a word vector model such as word2vec, glove and fasttext.

According to some embodiments, instead of performing steps S3050 to S3054, step S305 may include obtaining, based on the plurality of words in the text, the third text feature through a pre-trained feature extraction model. By utilizing the model pre-trained from a big corpus, the obtaining of the text feature associated with the semantic element of the words of the text can be simplified.

According to some embodiments, step S308 as shown in FIG. 3 may be the classification of the text based on the fused feature of the first to third text features. That is, the fused feature here may be obtained by performing, for example, addition calculation, weighted average calculation, or feature splicing on the first to third text features. In this way, it is convenient to flexibly select a manner of fusing the features according to different classification accuracy requirements and computing requirements.

It should be noted that, although FIG. 3 is described as an example in which step S305 and steps S302 to S306 are executed in parallel, the present disclosure does not limit the timing and sequence of the execution of step S305, as long as the fusion of the three text features may be realized in the end. For example, step S305 may be performed sequentially after step S306, or may be performed in an interspersal way during the process of steps S302 to S306.

As mentioned above, the method according to the embodiment of the present disclosure does not rely on the semantic element coming from the text segmentation, yet this semantic element may be used as an additional dimension for obtaining a further text feature, thereby improving the accuracy of the fused feature. Therefore, it can be understood that the semantic element about the text segmentation does not serve as the basis of the text classification method of the present disclosure, but plays a role in assisting in improving the classification accuracy.

FIG. 4 shows a schematic diagram for illustrating a method for text classification according to an embodiment of the present disclosure.

As shown in FIG. 4, a text 400 to be classified may be, for example, any short text in a dataset of short texts obtained in advance. A first processing branch 401 may represent processing of the semantic element about the entity category, and a second processing branch 402 may represent processing of the semantic element about the part-of-speech tag. The execution order of the first processing branch 401 and the second processing branch 402 may be sequential or in parallel, and the present disclosure does not limit the execution order of the steps involved therein.

In the first processing branch 401 and the second processing branch 402, the entity category set 4011 and the part-of-speech tag set 4021 associated with the text 400 to be classified may be obtained.

A first isomorphic graph 4012 for the entity category set 4011 and a second isomorphic graph 4022 for the part-of-speech tag set 4021 may be constructed. The node of the first isomorphic graph 4012 may correspond to the entity category in the entity category set 4011, and the node of the second isomorphic graph 4022 may correspond to the part-of-speech tag in the part-of-speech tag set 4021.

Based on the first isomorphic graph 4012, a first text feature 4014 of the text 400 to be classified expressing on the first isomorphic graph 4012 may be obtained through a first graph neural network 4013. Similarly, based on the second isomorphic graph 4022, a second text feature 4024 of the text 400 to be classified expressing on the second isomorphic graph 4022 may be obtained through a second graph neural network 4023.

For example, a feature expression H of the text on an individual isomorphic graph may be obtained by the following Formula 1:

H=Âσ(ÂXW₁)W₂ (Formula 1)

where Â represents a result of regularizing the adjacency matrix A of the isomorphic graph, where Â=D^{-0.5}(I+A)D^{-0.5}, and D represents a diagonal matrix ([D]ᵢᵢ=Σⱼ[A]ᵢⱼ); X represents the feature vector of the node in the isomorphic graph, σ( ) represents an activation function; and W₁ and W₂ represent the weights to be learnt by the graph neural network. According to the above Formula 1, through the individual first graph neural network 4013 and second graph neural network 4023, the first text feature 4014, i.e., H₁, from the first isomorphic graph 4012 about the entity category, and the second text feature 4024, i.e., H₂, from the second isomorphic graph 4022 about the part-of-speech tag may be obtained, respectively.

As mentioned above, the method according to the embodiment of the present disclosure improves the classification effect by fusing with other available semantic information, that is, the first processing branch 401 corresponding to the semantic element of the entity category and the second processing branch 402 corresponding to the semantic element of the part-of-speech tag. Additionally, in order to further improve the accuracy of the fused feature, the semantic element of the words of the text, i.e., the third processing branch 403 corresponding to the semantic element of the words of the text, may be used.

In the third processing branch 403, based on the plurality of words constituting the text 400 to be classified, a third text feature 4032 as to the semantic element about the words may be obtained via feature extraction processing 4031. The feature extraction processing 4031 may be performed in a manner similar as that the semantic elements about the entity category and the part-of-speech tag, i.e., performed based on the isomorphic graph and the graph neural network. Alternatively, the feature extraction processing 4031 may be performed with the aid of the pre-trained feature extraction model.

A fused feature 404 may be obtained by fusing the first to third text features, and the text 400 to be classified is classified by a classifier 405 based on the fused feature 404.

As mentioned above, according to the method of the embodiment of the present disclosure, the classification of the text does not rely on the semantic information deriving from the words themselves of the text, but individual text features of the text in other dimensions of semantic information are obtained, in which individual isomorphic graphs are constructed according to the other dimensions of semantic information and the individual text features of the text in the other dimensions are obtained through the graph neural network based on the individual isomorphic graphs. The text is then classified through the fused feature. In other words, the first processing branch 401 and the second processing branch 402 in FIG. 4 serve as the basis of the text classification method of the present disclosure, and the third processing branch 403 plays a role of assisting in improving the classification accuracy. Through this structure, on one hand, the problem of the limited classification effect caused by relying on the semantic information of the text itself can be avoided, and on the other hand, the computing complexity faced by processing in one isomorphic graph can be reduced, and the problem that the entire graph structure has to be changed when new semantic elements are introduced can also be avoided, thereby improving the text classification effect.

According to another aspect of the present disclosure, an apparatus for text classification is further provided. FIG. 5 shows a block diagram of an apparatus 500 for text classification according to an embodiment of the present disclosure. As shown in FIG. 5, the apparatus 500 may include a first obtaining unit 502, which may be configured to obtain a entity category set and a part-of-speech tag set associated with a text; a construction unit 504, which may be configured to construct a first isomorphic graph for the entity category set and a second isomorphic graph for the part-of-speech tag set, wherein a node of the first isomorphic graph corresponds to an entity category in the entity category set, and a node of the second isomorphic graph corresponds to a part-of-speech tag in the part-of-speech tag set; a second obtaining unit 506, which may be configured to obtain, based on the first isomorphic graph and the second isomorphic graph, a first text feature and a second text feature of the text through a graph neural network; and a classification unit 508, which may be configured to classify the text based on a fused feature of the first text feature and the second text feature.

The operations executed by the above modules 502, 504, 506 and 508 correspond to steps S202, S204, S206 and S208 described with reference to FIG. 2, so the details thereof will not be repeated.

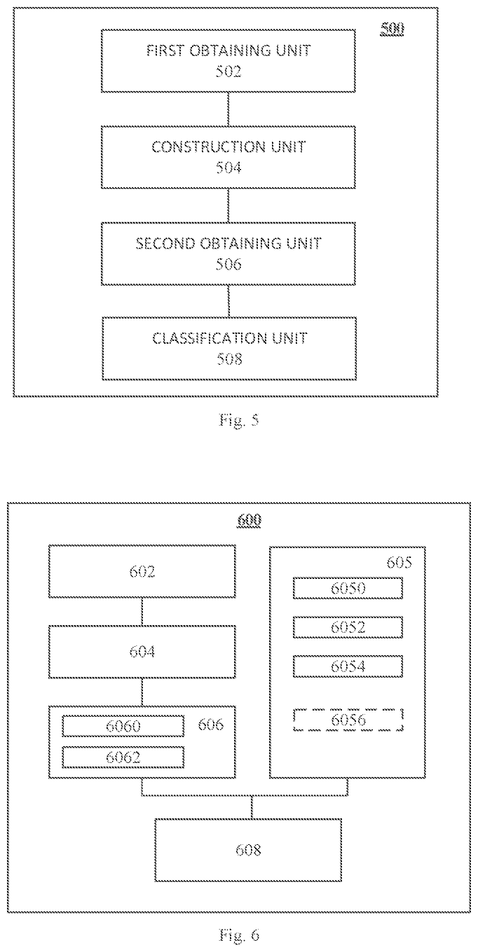

FIG. 6 shows a block diagram of an apparatus for text classification 600 according to another embodiment of the present disclosure. Modules 602, 604 and 606 as shown in FIG. 6 may correspond to the modules 502, 504 and 506 as shown in FIG. 5, respectively. Besides, the apparatus 600 may further include a functional module 605, and the modules 605 and 606 may include further sub-functional modules, which will be described in detail below.

According to some embodiments, the graph neural network may include a first sub-graph neural network and a second sub-graph neural network, and the second obtaining unit 606 may include a first subunit 6060, which may be configured to obtain first feature information for representing the first isomorphic graph and second feature information for representing the second isomorphic graph; and a second sub-unit 6062, which may be configured to input the first feature information and the second feature information to the first sub-graph neural network and the second sub-graph neural network to obtain the first text feature and the second text feature, respectively.

According to some embodiments, the first feature information and the second feature information may each include an adjacency matrix and a feature vector of the node associated with the corresponding isomorphic graph.

According to some embodiments, the apparatus 600 may further include a third obtaining unit 605, which may be configured to obtain, based on a plurality of words constituting the text, a third text feature of the text, wherein the fused feature further includes the third text feature.

According to some embodiments, the graph neural network may include a third sub-graph neural network for obtaining the third text feature, wherein the third obtaining unit 605 may include a third sub-unit 6050, which may be configured to obtain a word set including the plurality of words; a fourth sub-unit 6052, which may be configured to construct a third isomorphic graph for the word set, wherein a node of the third isomorphic graph corresponds to the word in the word set, and a fifth sub-unit 6054, which may be configured to obtain, based on an adjacency matrix and a feature vector of the node associated with the third isomorphic graph, the third text feature through the third sub-graph neural network.

According to some embodiments, alternatively, the third obtaining unit 605 may include a sixth sub-unit 6056, which may be configured to obtain, based on the plurality of words of the text, the third text feature through a pre-trained feature extraction model.

According to some embodiments, the fused feature may be obtained by performing addition calculation, weighted average calculation or feature splicing.

In the embodiment of the apparatus 600 as shown in FIG. 6, compared to the apparatus 500 shown in FIG. 5, the classification unit 608 may be configured to classify the text based on the fused feature of the first to third text features.

The operations performed by the above module 605 and its sub-modules 6050, 6052, and 6054 correspond to step S305 and its sub-steps S3050, S3052, and S3054 described with reference to FIG. 3, so the details thereof will not be repeated.

According to another aspect of the present disclosure, a non-transitory computer-readable storage medium storing computer instructions is further provided, wherein the computer instructions are configured to enable a computer to perform the method as described above.

According to another aspect of the present disclosure, a computer program product is further provided, including a computer program, wherein the computer program, when executed by a processor, implements the method as described above.

According to another aspect of the present disclosure, an electronic device is further provided, including at least one processor, and a memory in communication connection to the at least one processor, wherein the memory stores instructions executable by the at least one processor, and the instructions, when executed by the at least one processor, enable the at least one processor to perform the method as described above.

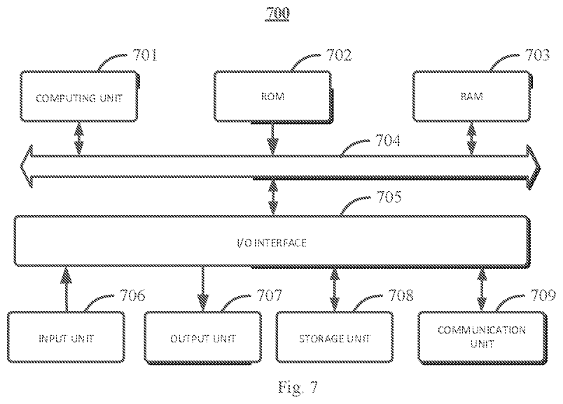

Referring to FIG. 7, a structural block diagram of an electronic device 700 that may be applied to the present disclosure will be described, which is an example of a hardware device that may be applied to various aspects of the present disclosure. The electronic device is intended to represent various forms of digital electronic computer devices, such as laptop computers, desktop computers, workstations, personal digital assistants, servers, blade servers, mainframe computers, and other suitable computers. The electronic device may also represent various forms of mobile devices, such as personal digital processors, cellular phones, smart phones, wearable devices, and other similar computing devices. The components shown herein, their connections and relationships, and their functions are by way of example only, and are not intended to limit implementations of the present disclosure described and/or claimed herein.

As shown in FIG. 7, the electronic device 700 includes a computing unit 701, which may perform various appropriate actions and processes according to a computer program stored in a read only memory (ROM) 702 or a computer program loaded into a random access memory (RAM) 703 from a storage unit 708. In the RAM 703, various programs and data necessary for the operation of the electronic device 700 may also be stored. The computing unit 701, the ROM 702, and the RAM 703 are connected to each other through a bus 704. An input/output (I/O) interface 705 is also connected to the bus 704.

Various components in the electronic device 700 are connected to the I/O interface 705, including an input unit 706, an output unit 707, the storage unit 708, and a communication unit 709. The input unit 706 may be any type of device capable of inputting information to the electronic device 700. The input unit 706 may receive the input numerical or character information, and generate a key signal input related to user settings and/or function control of the electronic device, and may include, but is not limited to, a mouse, a keyboard, a touch screen, a trackpad, a trackball, a joystick, a microphone and/or a remote control. The output unit 707 may be any type of device capable of presenting information, and may include, but is not limited to, a display, speakers, video/audio output terminals, vibrators, and/or printers. The storage unit 708 may include, but is not limited to, magnetic disks and compact discs. The communication unit 709 allows the electronic device 700 to exchange information/data with other devices through a computer network such as the Internet and/or various telecommunication networks, and may include, but is not limited to, modems, network cards, infrared communication devices, wireless communication transceivers and/or chips groups, such as Bluetooth™ devices, 802.11 devices, WiFi devices, WiMax devices, cellular communication devices and/or the like.

The computing unit 701 may be various general purpose and/or special purpose processing components with processing and computing capabilities. Some examples of the computing unit 701 include, but are not limited to, central processing units (CPUs), graphics processing units (GPUs), various specialized artificial intelligence (AI) computing chips, various computing units that run machine learning model algorithms, digital signal processors (DSPs), and any suitable processor, controller, microcontroller, etc. The computing unit 701 performs the various methods and processes described above, such as the method for text classification. For example, in some embodiments, the method for text classification may be implemented as a computer software program tangibly embodied on a machine-readable medium, such as the storage unit 708. In some embodiments, part or all of the computer program may be loaded and/or installed on the electronic device 700 via the ROM 702 and/or the communication unit 709. When the computer program is loaded to the RAM 703 and executed by the computing unit 701, one or more steps of the method for text classification described above may be performed. Alternatively, in other embodiments, the computing unit 701 may be configured to perform the method for text classification by any other suitable means (for example, by means of firmware).

Various implementations of the systems and technologies described above in this paper may be implemented in a digital electronic circuit system, an integrated circuit system, a field programmable gate array (FPGA), an application specific integrated circuit (ASIC), an application specific standard part (ASSP), a system on chip (SOC), a load programmable logic device (CPLD), computer hardware, firmware, software and/or their combinations. These various implementations may include: being implemented in one or more computer programs, wherein the one or more computer programs may be executed and/or interpreted on a programmable system including at least one programmable processor, and the programmable processor may be a special-purpose or general-purpose programmable processor, and may receive data and instructions from a storage system, at least one input apparatus, and at least one output apparatus, and transmit the data and the instructions to the storage system, the at least one input apparatus, and the at least one output apparatus.

Program codes for implementing the methods of the present disclosure may be written in any combination of one or more programming languages. These program codes may be provided to processors or controllers of a general-purpose computer, a special-purpose computer or other programmable data processing apparatuses, so that when executed by the processors or controllers, the program codes enable the functions/operations specified in the flow diagrams and/or block diagrams to be implemented. The program codes may be executed completely on a machine, partially on the machine, partially on the machine and partially on a remote machine as a separate software package, or completely on the remote machine or server.

In the context of the present disclosure, a machine readable medium may be a tangible medium that may contain or store a program for use by or in connection with an instruction execution system, apparatus or device. The machine readable medium may be a machine readable signal medium or a machine readable storage medium. The machine readable medium may include but not limited to an electronic, magnetic, optical, electromagnetic, infrared, or semiconductor system, apparatus or device, or any suitable combination of the above contents. More specific examples of the machine readable storage medium will include electrical connections based on one or more wirings, a portable computer disk, a hard disk, a random access memory (RAM), a read only memory (ROM), an erasable programmable read only memory (EPROM or flash memory), an optical fiber, a portable compact disk read only memory (CD-ROM), an optical storage device, a magnetic storage device, or any suitable combination of the above contents.

In order to provide interactions with users, the systems and techniques described herein may be implemented on a computer, and the computer has: a display apparatus for displaying information to the users (e.g., a CRT (cathode ray tube) or LCD (liquid crystal display) monitor); and a keyboard and a pointing device (e.g., a mouse or trackball), through which the users may provide input to the computer. Other types of apparatuses may further be used to provide interactions with users; for example, feedback provided to the users may be any form of sensory feedback (e.g., visual feedback, auditory feedback, or tactile feedback), an input from the users may be received in any form (including acoustic input, voice input or tactile input).

The systems and techniques described herein may be implemented in a computing system including background components (e.g., as a data server), or a computing system including middleware components (e.g., an application server) or a computing system including front-end components (e.g., a user computer with a graphical user interface or a web browser through which a user may interact with the implementations of the systems and technologies described herein), or a computing system including any combination of such background components, middleware components, or front-end components. The components of the system may be interconnected by digital data communication (e.g., a communication network) in any form or medium. Examples of the communication network include: a local area network (LAN), a wide area network (WAN) and the Internet.

A computer system may include a client and a server. The client and the server are generally remote from each other and usually interact through a communication network. The relationship of the client and the server arises by computer programs running on respective computers and having a client-server relationship to each other. The server may be a cloud server, a server of a distributed system, or a server combined with blockchain.

It should be understood that steps may be reordered, added or deleted using the various forms of flow shown above. For example, the steps described in the present disclosure may be executed in parallel, sequentially or in different orders, as long as desired results of a technical solution disclosed in the present disclosure may be achieved, and are not limited herein.

In the technical solution of the present disclosure, the acquisition, storage and application of involved personal information of users all comply with the provisions of relevant laws and regulations, and do not violate public order and good customs. The intent of the present disclosure is that personal information data should be managed and processed in a manner that minimizes the risk of inadvertent or unauthorized access to use. The risk is minimized by limiting data collection and deleting data when it is no longer needed. It should be noted that all information related to personnel in the present disclosure is collected with the knowledge and consent of the personnel.

Although the embodiments or examples of the present disclosure have been described with reference to the accompanying drawings, it should be understood that the above methods, systems and devices are merely example embodiments or examples, and the scope of the present invention is not limited by these embodiments or examples, but is limited only by the appended claims and their equivalents Various elements of the embodiments or examples may be omitted or replaced by equivalents thereof. Furthermore, the steps may be performed in an order different from that described in the present disclosure. Further, the various elements of the embodiments or examples may be combined in various ways. Importantly, as technology evolves, many of the elements described herein may be replaced by equivalent elements that appear later in the present disclosure.

1. A computer-implemented method for text classification, comprising:
obtaining an entity category set and a part-of-speech tag set associated with a text;
constructing a first isomorphic graph for the entity category set and a second isomorphic graph for the part-of-speech tag set, wherein a node of the first isomorphic graph corresponds to an entity category in the entity category set, and a node of the second isomorphic graph corresponds to a part-of-speech tag in the part-of-speech tag set;
obtaining, based on the first isomorphic graph and the second isomorphic graph, a first text feature and a second text feature of the text through a graph neural network; and
classifying the text based on a fused feature of the first text feature and the second text feature.

2. The method according to claim 1, wherein the graph neural network comprises a first sub-graph neural network and a second sub-graph neural network independent from each other, and wherein obtaining, based on the first isomorphic graph and the second isomorphic graph, the first text feature and the second text feature of the text through the graph neural network comprises:
obtaining first feature information for representing the first isomorphic graph and second feature information for representing the second isomorphic graph; and
inputting the first feature information and the second feature information to the first sub-graph neural network and the second sub-graph neural network to obtain the first text feature and the second text feature, respectively.

3. The method according to claim 2, wherein the first feature information and the second feature information each comprises an adjacency matrix and a feature vector of the node associated with the respective isomorphic graph.

4. The method according to claim 1, further comprising:
obtaining, based on a plurality of words constituting the text, a third text feature of the text, wherein the fused feature is a fused feature of the first text feature, the second text feature, and the third text feature.

5. The method according to claim 4, wherein the graph neural network comprises a third sub-graph neural network for obtaining the third text feature, and wherein obtaining, based on the plurality of words constituting the text, the third text feature of the text comprises:
obtaining a word set comprising the plurality of words;
constructing a third isomorphic graph for the word set, wherein a node of the third isomorphic graph corresponds to a word in the word set; and
obtaining, based on an adjacency matrix and a feature vector of the node associated with the third isomorphic graph, the third text feature through the third sub-graph neural network.

6. The method according to claim 4, wherein obtaining, based on the plurality of words constituting the text, the third text feature of the text comprises:
obtaining, based on the plurality of words of the text, the third text feature through a pre-trained feature extraction model.

7. The method according to claim 1, wherein the fused feature is obtained by performing addition calculation, weighted average calculation or feature splicing.

8. An electronic device, comprising:
at least one processor; and
a memory in communication connection to the at least one processor,
wherein the memory stores instructions executable by the at least one processor, and the instructions, when executed by the at least one processor, enable the at least one processor to perform processing comprising:
obtaining an entity category set and a part-of-speech tag set associated with a text;
constructing a first isomorphic graph for the entity category set and a second isomorphic graph for the part-of-speech tag set, wherein a node of the first isomorphic graph corresponds to an entity category in the entity category set, and a node of the second isomorphic graph corresponds to a part-of-speech tag in the part-of-speech tag set;
obtaining, based on the first isomorphic graph and the second isomorphic graph, a first text feature and a second text feature of the text through a graph neural network; and
classifying the text based on a fused feature of the first text feature and the second text feature.

9. The electronic device according to claim 8, wherein the graph neural network comprises a first sub-graph neural network and a second sub-graph neural network independent from each other, and wherein obtaining, based on the first isomorphic graph and the second isomorphic graph, the first text feature and the second text feature of the text through the graph neural network comprises:
obtaining first feature information for representing the first isomorphic graph and second feature information for representing the second isomorphic graph; and
inputting the first feature information and the second feature information to the first sub-graph neural network and the second sub-graph neural network to obtain the first text feature and the second text feature, respectively.

10. The electronic device according to claim 9, wherein the first feature information and the second feature information each comprises an adjacency matrix and a feature vector of the node associated with the respective isomorphic graph.

11. The electronic device according to claim 8, further comprising:
obtaining, based on a plurality of words constituting the text, a third text feature of the text, wherein the fused feature is a fused feature of the first text feature, the second text feature, and the third text feature.

12. The electronic device according to claim 11, wherein the graph neural network comprises a third sub-graph neural network for obtaining the third text feature, and wherein obtaining, based on the plurality of words constituting the text, the third text feature of the text comprises:
obtaining a word set comprising the plurality of words;
constructing a third isomorphic graph for the word set, wherein a node of the third isomorphic graph corresponds to a word in the word set, and
obtaining, based on an adjacency matrix and a feature vector of the node associated with the third isomorphic graph, the third text feature through the third sub-graph neural network.

13. The electronic device according to claim 11, wherein obtaining, based on the plurality of words constituting the text, the third text feature of the text comprises:
obtaining, based on the plurality of words of the text, the third text feature through a pre-trained feature extraction model.

14. The electronic device according to claim 8, wherein the fused feature is obtained by performing addition calculation, weighted average calculation or feature splicing.

15. A non-transitory computer-readable storage medium storing computer instructions, wherein the computer instructions are configured to enable a computer to perform processing comprising:
obtaining an entity category set and a part-of-speech tag set associated with a text;
constructing a first isomorphic graph for the entity category set and a second isomorphic graph for the part-of-speech tag set, wherein a node of the first isomorphic graph corresponds to an entity category in the entity category set, and a node of the second isomorphic graph corresponds to a part-of-speech tag in the part-of-speech tag set;
obtaining, based on the first isomorphic graph and the second isomorphic graph, a first text feature and a second text feature of the text through a graph neural network; and
classifying the text based on a fused feature of the first text feature and the second text feature.
